(19) United States
(12) Patent Application Publication
(10) Pub. No.: US 2018/0157663 A1
(43) Pub. Date: Jun. 7, 2018

(54) SYSTEMS AND METHODS FOR USER CLUSTERING

(71) Applicant: Facebook, Inc., Menlo Park, CA (US)

(72) Inventors: Komal Kapoor, Bellevue, WA (US); Aryamman Jain, Menlo Park, CA (US); Bradley Ray Green, Snohomish, WA (US)

(21) Appl. No.: 15/371,181

(22) Filed: Dec. 6, 2016

(51) Int. Cl. G06F 17/30; G06N 7/00; H04L 29/08; G06N 3/08

(52) U.S. Cl. CPC G06F 17/3053; G06N 7/005; G06N 3/08; G06F 17/30675; H04L 67/22

(57) ABSTRACT

Systems, methods, and non-transitory computer-readable media can calculate user similarity scores for a plurality of users on a social networking system with respect to a first user based on user embeddings for the plurality of users and the first user. A set of similar users comprising a plurality of similar users is determined based on the user similarity scores. Page recommendation scores are calculated for a plurality of pages associated with the plurality of similar users based on the user similarity scores. One or more page recommendations are determined for the first user based on the page recommendation scores.

### FIELD OF THE INVENTION

The present technology relates to the field of social networking systems. More particularly, the present technology relates to systems and methods for user clustering.

### BACKGROUND

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can be given the opportunity to interact with pages on the social networking system that are associated with other users or entities. For example, a user can “follow” or “like” a page associated with a particular entity or concept. A user's decision to interact with a particular page on a social networking system generally represents an indication of interest in the entity associated with the page. As the social networking system gains more information about the types of pages a user interacts with, the social networking system gains knowledge about the user and the user's interests, and can utilize that knowledge to optimize content, products, and services offered to the user.

### SUMMARY

Various embodiments of the present disclosure can include systems, methods, and non-transitory computer readable media configured to calculate user similarity scores for a plurality of users on a social networking system with respect to a first user based on user embeddings for the plurality of users and the first user. A set of similar users comprising a plurality of similar users is determined based on the user similarity scores. Page recommendation scores are calculated for a plurality of pages associated with the plurality of similar users based on the user similarity scores. One or more page recommendations are determined for the first user based on the page recommendation scores.

In an embodiment, for each user in the plurality of users, the user similarity score is calculated based on a cosine similarity between the embedding for the user and the embedding for the first user.

In an embodiment, for each page of the plurality of pages, the page recommendation score is calculated based on the user similarity scores for all similar users that have fanned the page.

In an embodiment, for each page of the plurality of pages, the page recommendation score is calculated based on a sum of the user similarity scores for all similar users that have fanned the page.

In an embodiment, a set of potential page recommendations is determined. The set of potential page recommendations comprises all pages fanned by the similar users in the set of similar users that have not already been fanned by the first user. The calculating page recommendation scores for the plurality of pages associated with the plurality of similar users comprises calculating page recommendation scores for each page in the set of potential page recommendations

In an embodiment, the user embeddings for the plurality of users and the first user are generating using paragraph embeddings.

In an embodiment, training data for the user embeddings comprises a plurality of sentences comprising one or more words, each sentence of the plurality of sentences is associated with a user of the plurality of users, and, for each sentence, each word in the sentence is associated with a page that the user associated with the sentence has fanned.

In an embodiment, the user embeddings for the plurality of users and the first user are generated using a linear embedding system augmented with traits.

In an embodiment, the user embeddings for the plurality of users and the first user are generated using neural linguistic embeddings.

In an embodiment, training data for the user embeddings comprises a plurality of sentences comprising one or more words, each sentence of the plurality of sentences is associated with a page on the social networking system, and, for each sentence, each word in the sentence is associated with user that has fanned the page associated with the sentence.

It should be appreciated that many other features, applications, embodiments, and/or variations of the disclosed technology will be apparent from the accompanying drawings and from the following detailed description. Additional and/or alternative implementations of the structures, systems, non-transitory computer readable media, and methods described herein can be employed without departing from the principles of the disclosed technology.

### BRIEF DESCRIPTION OF THE DRAWINGS

FIG. 1 illustrates an example system including a user clustering module, according to an embodiment of the present disclosure.

FIG. 2 illustrates an example vector representation module, according to various embodiments of the present disclosure.

FIG. 3 illustrates an example similar user determination module, according to an embodiment of the present disclosure.

FIG. 4 illustrates an example page recommendation module, according to an embodiment of the present disclosure.

FIG. 5 illustrates an example method associated with providing page recommendations based on user clustering, according to an embodiment of the present disclosure.

FIG. 6 illustrates a network diagram of an example system including an example social networking system that can be utilized in various scenarios, according to an embodiment of the present disclosure.

FIG. 7 illustrates an example of a computer system or computing device that can be utilized in various scenarios, according to an embodiment of the present disclosure.

The figures depict various embodiments of the disclosed technology for purposes of illustration only, wherein the figures use like reference numerals to identify like elements. One skilled in the art will readily recognize from the following discussion that alternative embodiments of the structures and methods illustrated in the figures can be employed without departing from the principles of the disclosed technology described herein.

### DETAILED DESCRIPTION

### User Clustering Based on Social Engagement

Today, people often utilize computing devices (or systems) for a wide variety of purposes. Users can use their computing devices, for example, to interact with one another, create content, share content, and view content. In some cases, a user can utilize his or her computing device to access a social networking system (or service). The user can provide, post, share, and access various content items, such as status updates, images, videos, articles, and links, via the social networking system.

Users of a social networking system can be given the opportunity to interact with pages on the social networking system that are associated with other users or entities. For example, a user can “follow” or “like” a page associated with a particular entity or concept. A user's decision to interact with a particular page on a social networking system generally represents an indication of interest in the entity associated with the page. As the social networking system gains more information about the types of pages a user interacts with, the social networking system gains knowledge about the user and the user's interests, and can utilize that knowledge to optimize content, products, and services offered to the user.

It continues to be an important interest for a social networking system to encourage user interaction on the social networking system. Continued user interaction with other accounts or pages on the social networking system is an important aspect of maintaining continued interest in and participation on the social networking system. Consistent with this interest, social networking systems may provide recommendations of pages that may be of interest to a user, with the goal of encouraging the user to interact with those pages. However, despite the abundance of content that may be available on a social networking system, it can be difficult to consistently provide users with content that is new and interesting. For example, it can be difficult to introduce users to pages that they might be interested in interacting with or forming a connection with. Conventional approaches to page recommendations can suffer from several common drawbacks. For example, recommendation systems may provide users with a large number of recommendations without due consideration for whether those recommendations would actually be of interest to the user. Making too many recommendations that are not of interest to a user may lead to users ignoring or disregarding recommendations made by the social networking system.

An improved approach rooted in computer technology overcomes the foregoing and other disadvantages associated with conventional approaches specifically arising in the realm of computer technology. In general, users can be clustered into groups of similar users based on similarities in page interactions, such as page “fanning” (e.g., following or liking a page, or otherwise indicating interest in a page). In certain embodiments, vector representations of users can be generated based on pages users have fanned. For example, in various embodiments, various vector representation methodologies can be utilized to create vector representations (sometimes referred to as “embeddings”) for users. Some examples of vector representation methodologies include a linear embedding system augmented with traits (e.g., item-to-item (“i2i”) collaborative filtering), neural linguistic embeddings (e.g., word2vec embeddings), and paragraph embeddings (e.g., doc2vec embeddings). Vector representations can be used to determine users that are similar to one another. For example, for a first user, a vector representation of the first user can be compared to vector representations of other users on the social networking system to determine a set of similar users comprising one or more users that are similar to the first user. In certain embodiments, similarity between users can be determined based on a distance calculation, such as a cosine similarity calculation, between two vectors. In various embodiments, pages that have been fanned by users in the set of similar users, but have not yet been fanned by the first user, can potentially be recommended to the first user as page recommendations.

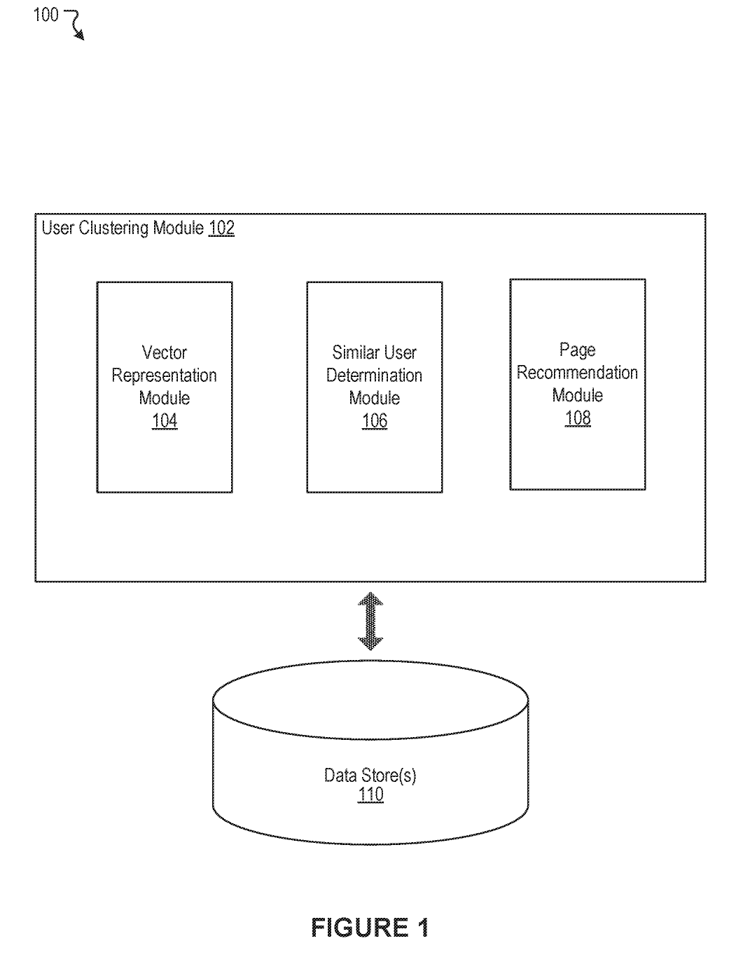

FIG. 1 illustrates an example system 100 including an example user clustering module 102, according to an embodiment of the present disclosure. The user clustering module 102 can be configured to cluster users based on similarities in page fanning. In various embodiments, users can be clustered by generating vector representations of users, and comparing the vector representations to one another. For example, vector representations, or embeddings, can be generated for each user using any suitable embedding methodology, e.g., linear embedding systems augmented with traits, neural linguistic embeddings, paragraph embeddings, etc. Embeddings for each user can be generated based on pages that the user has fanned on a social networking system. User embeddings can then be compared with one another to determine similar users. For example, for a first user, the first user's embedding can be compared to the embeddings of other users on the social networking system to determine a set of similar users. In various embodiments, similar users can be determined by calculating cosine similarities between the first user's embedding and the embeddings of other users on the social networking system, and/or calculating nearest neighbors for the first user's embedding. In certain embodiments, the set of similar users can be determined based on user similarity scores assigned to each user with respect to the first user. The set of similar users can be evaluated to determine a set of potential page recommendations comprising one or more pages that have been fanned by the set of similar users but have not been fanned by the first user. In certain embodiments, page recommendation scores can be assigned to each page in the set of potential page recommendations, and page recommendations can be determined based on the page recommendation scores. The set of potential page recommendations can be ranked based on page recommendation score, and one or more page recommendations can be provided to the first user based on the ranking.

As shown in the example of FIG. 1, the user clustering module 102 can include a vector representation module 104, a similar user determination module 106, and a page recommendation module 108. In some instances, the example system 100 can include at least one data store 110. The components (e.g., modules, elements, etc.) shown in this figure and all figures herein are exemplary only, and other implementations may include additional, fewer, integrated, or different components. Some components may not be shown so as not to obscure relevant details. In various embodiments, one or more of the functionalities described in connection with the user clustering module 102 can be implemented in any suitable combinations.

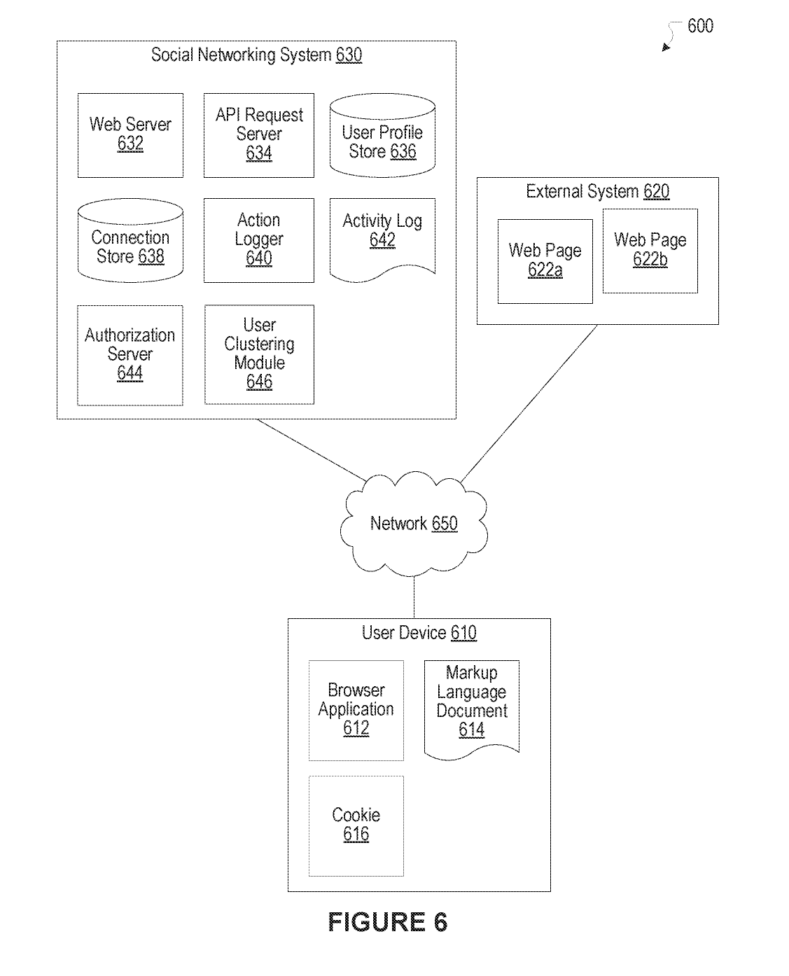

In some embodiments, the user clustering module 102 can be implemented, in part or in whole, as software, hardware, or any combination thereof. In general, a module, as discussed herein, can be associated with software, hardware, or any combination thereof. In some implementations, one or more functions, tasks, and/or operations of modules can be carried out or performed by software routines, software processes, hardware, and/or any combination thereof. In some cases, the user clustering module 102 can be implemented, in part or in whole, as software running on one or more computing devices or systems, such as on a user or client computing device. For example, the user clustering module 102, or at least a portion thereof, can be implemented as or within an application (e.g., app), a program, or an applet, etc., running on a user computing device or a client computing system, such as the user device 610 of FIG. 6. In another example, the user clustering module 102, or at least a portion thereof, can be implemented using one or more computing devices or systems that include one or more servers, such as network servers or cloud servers. In some instances, the user clustering module 102 can, in part or in whole, be implemented within or configured to operate in conjunction with a social networking system (or service), such as the social networking system 630 of FIG. 6. It should be understood that there can be many variations or other possibilities.

The user clustering module 102 can be configured to communicate and/or operate with the at least one data store 110, as shown in the example system 100. The data store 110 can be configured to store and maintain various types of data. In some implementations, the data store 110 can store information associated with the social networking system (e.g., the social networking system 630 of FIG. 6). The information associated with the social networking system can include data about users, user identifiers, social connections, social interactions, profile information, demographic information, locations, geo-fenced areas, maps, places, events, pages, groups, posts, communications, content, feeds, account settings, privacy settings, a social graph, and various other types of data. In some embodiments, the data store 110 can store information that is utilized by the user clustering module 102. For example, the data store 110 can store user embeddings, page embeddings, similar user information, page fanning information, and the like. It is contemplated that there can be many variations or other possibilities.

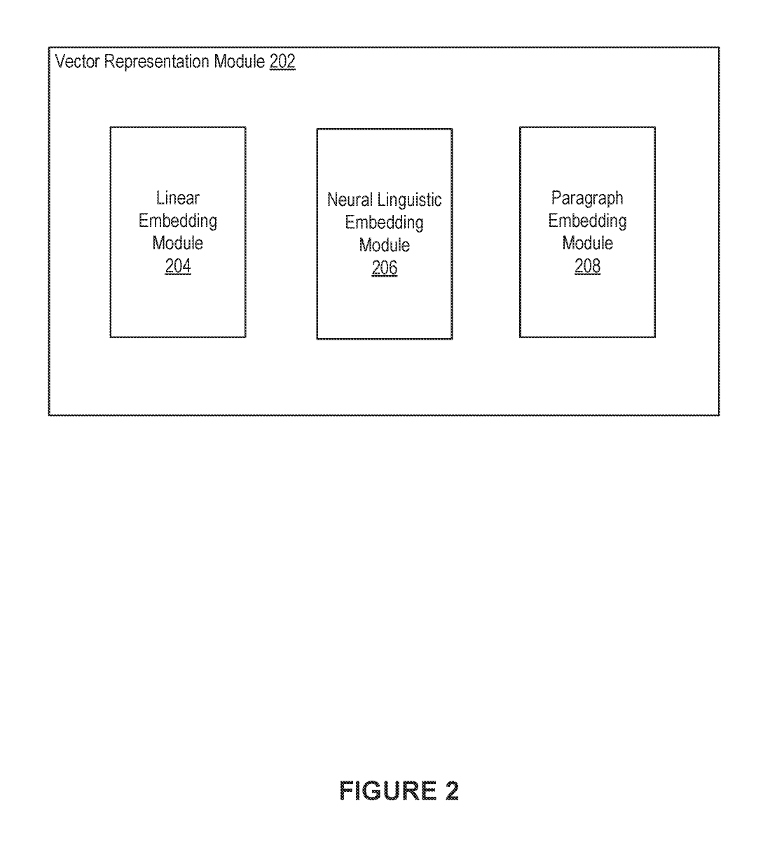

The vector representation module 104 can be configured to generate vector representations, or embeddings, for one or more users of a social networking system. In certain embodiments, a user embedding for a user can be generated based on page fanning data indicative of which pages on a social networking system the user has fanned. Various embedding methodologies can be used to create user embeddings, such as linear embedding systems augmented with traits, neural linguistic embeddings, paragraph embeddings, or any other suitable embedding technique. The vector representation module 104 is described in greater detail herein with reference to FIG. 2.

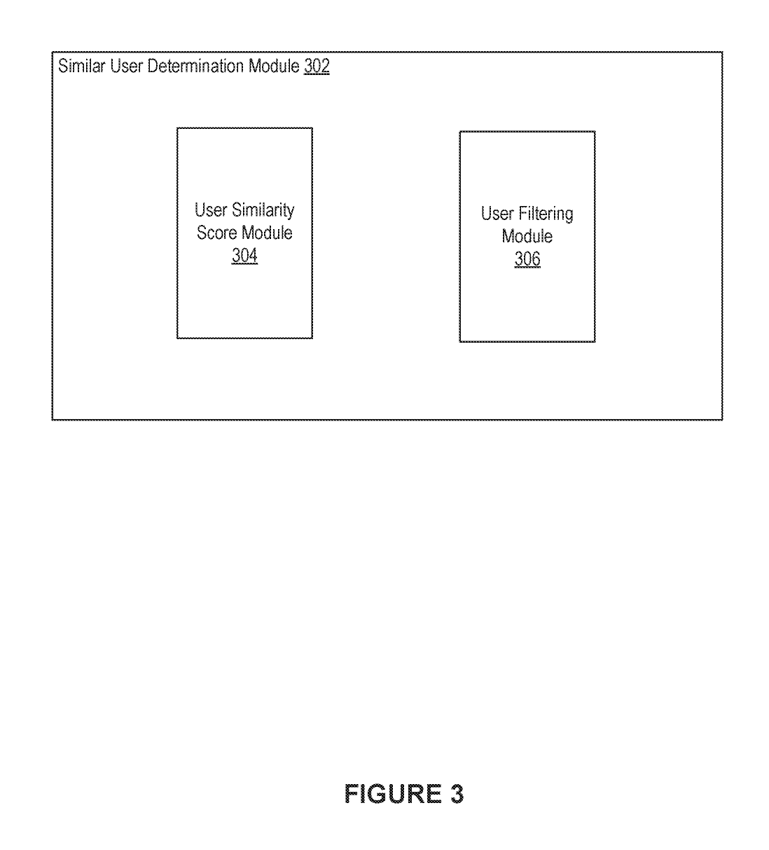

The similar user determination module 106 can be configured to determine user similarity between users on a social networking system based on user embeddings. In certain embodiments, for a first user, a set of similar users can be determined based on user embeddings. For example, user similarity scores can be calculated for users on the social networking system with respect to the first user. In certain embodiments, user similarity scores may be determined based at least in part on a cosine similarity between the first user's embedding and the embedding of another user. A set of similar users can be determined for the first user based on the user similarity scores. The similar user determination module 106 is described in greater detail herein with reference to FIG. 3.

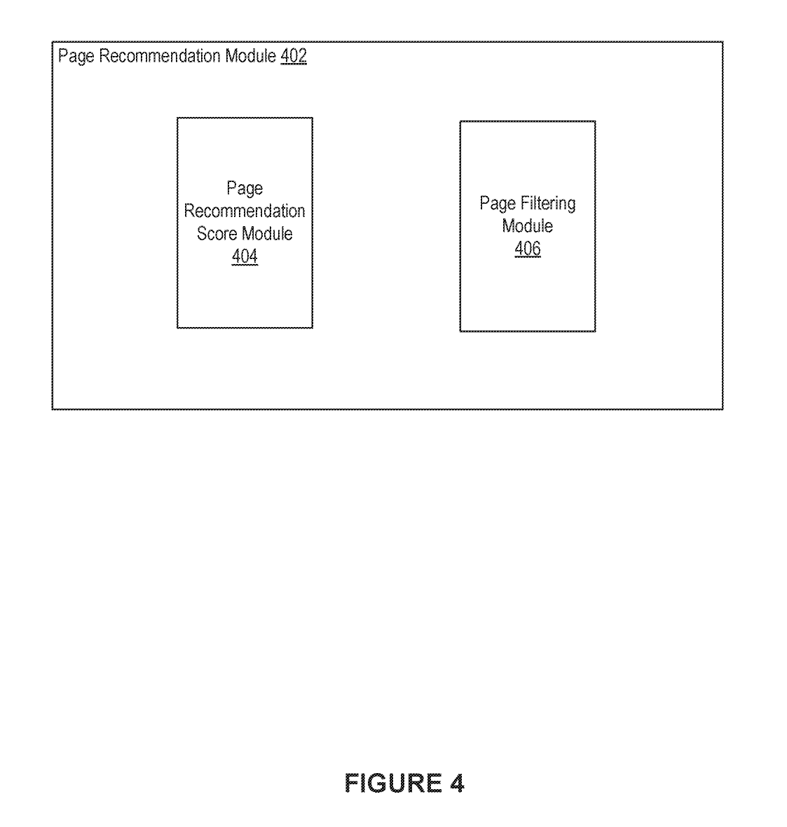

The page recommendation module 108 can be configured to generate page recommendations for a first user based on similar users for the first user. In certain embodiments, for a first user, a set of potential pages can be gathered by collecting all pages that have been fanned by users in a set of similar users for the first user. Each page in the set of potential pages can be assigned a page recommendation score, and a set of page recommendations can be determined based on the page recommendation scores. The page recommendation module 108 is described in greater detail herein with reference to FIG. 4.

FIG. 2 illustrates an example vector representation module 202 configured to generate vector representations, or embeddings, of users of a social networking system, according to an embodiment of the present disclosure. In some embodiments, the vector representation module 104 of FIG. 1 can be implemented as the vector representation module 202. As shown in the example of FIG. 2, the vector representation module 202 can include linear embedding module 204, a neural linguistic embedding module 206, and a paragraph embedding module 208. It should be understood that each of these modules represents a different embedding methodology by which user embeddings can be generated. Various systems and methods can utilize one of these methodologies for creating embeddings, or can use combinations of multiple embedding methodologies. In certain embodiments, other suitable methodologies for creating embeddings can be used.

The linear embedding module 204 can be configured to generate user embeddings based on linear embedding systems augmented with traits. In certain embodiments, each user of a social networking system can be represented as a vector in which each unit of the vector is representative of the user's preference for a particular page. A user's “preference” for a particular page can be demonstrated, for example, by whether or not the user has fanned the page. Similarity between users can be calculated by calculating a commonality, or an overlap, between the pages fanned by the users being compared. For example, consider the example scenario in which User X fans page (A), User Y fans pages (A, B, C), and User Z fans pages (B, C). Users X and Y are similar because of their intersection of page A. Users Y and Z are similar because of their intersection of pages B and C. Users Y and Z have a stronger similarity than users X and Y because the intersection is larger. Users X and Z are not similar, because there is no intersection between their fanned pages. As will be described in greater detail below, User X may be provided with page recommendations for pages B and C due to the fact that similar User Y has fanned those pages. User Z may be provided with a page recommendation for page A because similar User Y has fanned that page. In certain embodiments, User Y would not receive any page recommendations due to the fact that similar Users X and Z have not fanned any pages that have not already been fanned by User Y. Page recommendations based on user clustering will be described in greater detail herein with reference to FIG. 4.

Embeddings for users can be generated by first collecting “training data” for generating embeddings. The training data for generating vectors using linear embedding systems augmented with traits can comprise collecting edges between a page and a user, wherein an edge exists for each page that the user has fanned. Each edge can be assigned an edge score. For example, each page that a user has fanned can be assigned an edge score of 1.0. In other embodiments, different edge scores can be provided based on various user-page interaction characteristics. For example, these characteristics can include the time elapsed since the user fanned the page (e.g., more recently fanned pages given a higher score), the number of the user's connections on the social networking system who have fanned the page (e.g., higher score if a large number of the user's connections have fanned the page), the number or frequency of page visits for the user to the page (e.g., higher edge score for greater number or frequency of page visits), the number of user interactions between the user and the page (e.g., higher edge score for greater number of user interactions), and the like. In certain embodiments, edge scores may also be negative, such that negative interactions between a user and a page can result in a negative edge score. Negative interactions might include, for example, page visits without conversion (e.g., user visited a page but did not fan the page), pages that have been un-fanned by the user, etc.

In certain embodiments, training data may be limited such that not every user-page edge is utilized for training. For example, for pages that have greater than a threshold number of fans, only a subset of fans may be used as training data. For example, if a page has greater than 500 fans, then only the most recent 500 fans of a page may be included in the training data. Similarly, for users that have fanned greater than a threshold number of pages, only a subset of the user's fanned pages may be included in the training data. For example, if a user has fanned more than 250 pages, only the most recent 250 pages may be included in the training data.

The training data can be used to generate vector representations of users. As stated above, a vector representation for a particular user can be generated such that each unit (or element or value) of the vector is representative of the user's preference for a particular page. For example, each unit of the vector may include the edge score between the user and the particular page represented by the unit. For example, if a first unit represents a page that the user has not fanned, that unit may be a “0,” and if a second unit represents a page that the user has fanned, that unit may be a “1.” As discussed above, in certain embodiments, non-binary and even negative edge scores may be used.

The neural linguistic embedding module 204 can be configured to generate user embeddings based on a neural linguistic embedding methodology. Neural linguistic embedding methodologies generate embeddings of an individual word based on words surrounding the word in, for example, a single sentence. In the context of generating user embeddings based on page fanning, each “word” may represent a user, and each “sentence” may represent a page, such that each sentence comprises all users that have fanned a particular page. The training data for generating embeddings using neural linguistic embedding methodologies can include collecting, for each page, a list of users that have fanned the page to generate sentences for each page. The words in each sentence (i.e., the users that have fanned the page) can be ordered by time of fanning (e.g., ordered such that users who have most recently fanned the page are presented first, and users that fanned the page long ago are presented towards the end of the sentence). These sentences are then provided to the neural linguistic embedding training model to generate embeddings for each user (i.e., each “word”) in the sentence. In general, it may be desirable to train with a full window over a sessionized sentence such that all users in a sentence are embedded based on all other users in the sentence. However, in certain instances, this may not be practicable, and a smaller window size may be selected such that for each user in the sentence, the user's embedding is trained based on other users within the selected window size. For example, consider a page A that has five fans: fan1, fan2, fan3, fan4, and fan5. If the window size is selected as 1, then the window for fan2 would be: [fan1, fan2, fan 3] and fan2's embedding would be trained based on fan1 and fan3's fanning of page A. The embedding/training for fan2 can be undertaken based on the following equation: embed(fan2)←embed(fan2)+learning_rate*(1−softmax(embed(fan1), embed(fan3)).

The paragraph embedding module 206 can be configured to generate user embeddings based on paragraph embedding methodologies. Paragraph embedding methodologies combine neural linguistic embeddings to generate embeddings for both the words in a sentence and the sentence itself. In certain embodiments, using paragraph embedding methodologies, the sentence could be associated with a user (rather than a sentence representing a page, as was the case above with respect to neural linguistic embeddings), and each word in the sentence could represent pages fanned by the user. By training on this sentence using a paragraph embedding methodology, embeddings can be generated for pages as well as for users. The training data for generating embeddings using paragraph embedding methodologies can include, for each user, a list of pages fanned by the user. The words in each sentence (i.e., the pages that have been fanned by the user associated with the sentence) can be ordered by the time since the user fanned the page (e.g., ordered from most recently fanned page to oldest fanned page). In certain embodiments, a subset of the most recently fanned pages may be selected for each user having greater than a threshold number of fanned pages (e.g., the most recent 100 fanned pages). User sentences can then be provided to the paragraph embedding training model to generate embeddings for each user and each page.

FIG. 3 illustrates an example similar user determination module 302 configured to determine a set of similar users for a given user, according to an embodiment of the present disclosure. In some embodiments, the similar user determination module 106 of FIG. 1 can be implemented as the similar user determination module 302. As shown in the example of FIG. 3, the similar user determination module 302 can include a user similarity score module 304 and a user filtering module 306.

The user similarity score module 304 can be configured to calculate user similarity scores for one or more users on a social networking system with reference to a first user, indicative of a similarity between each user and the first user. In certain embodiments, a user similarity score for two users can be calculated based on embeddings/vector representations of the two users. In various embodiments, a cosine similarity can be calculated between the two user embeddings, and a user similarity score can be calculated based on the cosine similarity. For example, if user embeddings are generated using linear embedding systems augmented with traits, a cosine similarity can be calculated using the equation:

$$similarity ( {u}_{1} , {u}_{2} ) = \frac{{\sum }_{i} ( r ( {u}_{1} , {page}_{i} ) * r ( {u}_{2} , {page}_{i} ) )}{\sqrt{{\sum }_{i} {r ( {u}_{1} {page}_{i} )}^{x} * {\sum }_{i} {r ( {u}_{2} , {page}_{i} )}^{x}}}$$

where u1 is a first user, u2 is a second user, and the function r(user, page) represents the edge weight or edge score between a user and a page. The exponent “x” is a constant that may be varied to skew or tune results as desired. In certain embodiments, the user similarity score between a first user and a second user may be based on a combination of cosine similarities calculated using multiple values for x. For example, the cosine similarity between two users can be calculated three times, once using x=4, once using x=2, and once using x=4/3. The user similarity score between the two users can be determined based on the sum of the three cosine similarities calculated. Similarly, cosine similarities can be used to calculate user similarity scores for the neural linguistic embeddings and paragraph embeddings.

The user filtering module 306 can be configured to filter users based on user similarity scores to determine, for a given user, a set of similar users comprising one or more similar users. In certain embodiments, for a given first user, user similarity scores can be calculated for a plurality of other users on the social networking system with respect to the first user. The user similarity scores are indicative of how similar the other users are to the first user. The set of other users can be ranked and/or filtered based on user similarity scores to determine a set of similar users. For example, all users that satisfy a user ranking threshold (e.g., top 50 users based on user similarity scores) may be included in the set of similar users, or users that satisfy a user similarity score threshold (e.g., users having a user similarity score above n) can be included in the set of similar users. In another embodiment, a combination of user ranking threshold and user similarity score threshold can be used (e.g., the top n users that satisfy a similarity score threshold).

FIG. 4 illustrates an example page recommendation module 402 configured to determine one or more page recommendations to be provided to a user, according to an embodiment of the present disclosure. In some embodiments, the page recommendation module 108 of FIG. 1 can be implemented as the page recommendation module 402. As shown in the example of FIG. 4, the page recommendation module 402 can include a page recommendation score module 404 and a page filtering module 406.

The page recommendation score module 404 can be configured to calculate page recommendation scores for one or more pages on a social networking system with reference to a first user. In certain embodiments, for a particular user, a set of similar users can be determined, as discussed above. All pages fanned by each similar user in the set of similar users can be collected into a set of potential page recommendations. Any pages that have already been fanned by the first user can be removed or excluded from the set of potential page recommendations. Each page in the set of potential page recommendations can be assigned a page recommendation score. In certain embodiments, the page recommendation score for each page can be calculated based on the user similarity scores of similar users that have fanned that page. For example, the page recommendation score for a given page can equal the sum of the user similarity scores for all similar users that have fanned the page. Consider the example scenario in which user1 has a set of similar users that includes similar users user2 and user3. User2 has a user similarity score of 0.5, and user3 has a user similarity score of 0.3. User2 has fanned page1, page2, and page3, while user3 has fanned page3 and page4. The page recommendation score for page1 would be 0.5, the page recommendation score for page2 would also be 0.5, the page recommendation score for page3 would be 0.8 (as it has been fanned by both similar users), and the page recommendation score for page4 would be 0.3.

The page filtering module 406 can be configured to rank and/or filter the set of potential page recommendations to determine one or more page recommendations for a user based on page recommendation scores. In certain embodiments, pages satisfying a page ranking threshold may be selected for recommendation to a user (e.g., the top 3 pages based on page recommendation score). In other embodiments, pages satisfying a page recommendation score threshold can be selected for recommendation to a user (e.g., all pages having a page recommendation score above n). In other embodiments, pages satisfying both a page ranking threshold and a page recommendation score threshold may be selected for recommendation to a user (e.g., the top n pages that satisfy a page recommendation score threshold). Page recommendations can then be presented to a user for potential fanning and/or interaction by the user.

In certain embodiments, page embeddings may be used to generate page recommendations as well. In the above-described embodiments, user embeddings are used to calculate user similarity scores, which are used to calculate page recommendation scores, which are used to determine page recommendations. In certain embodiments, such as the embodiment in which a paragraph embedding methodology is utilized, page embeddings may also be generated. In paragraph embedding methodologies, page embeddings are generated in the same latent space as user embeddings. As such, page embeddings can be directly compared to one another, and also compared directly with user embeddings. The mapping of page embeddings in the same latent space as user embeddings can allow for determination of page recommendations in a variety of ways. For example, the nearest users to a first user can be determined, and the nearest pages to the nearest users can be recommended to the first user as page recommendations. In another example, the nearest pages to the first user that the first user has not already fanned can be presented to the first user as page recommendations. In yet another example, the nearest pages to the pages that the first user has already fanned can be selected as page recommendations.

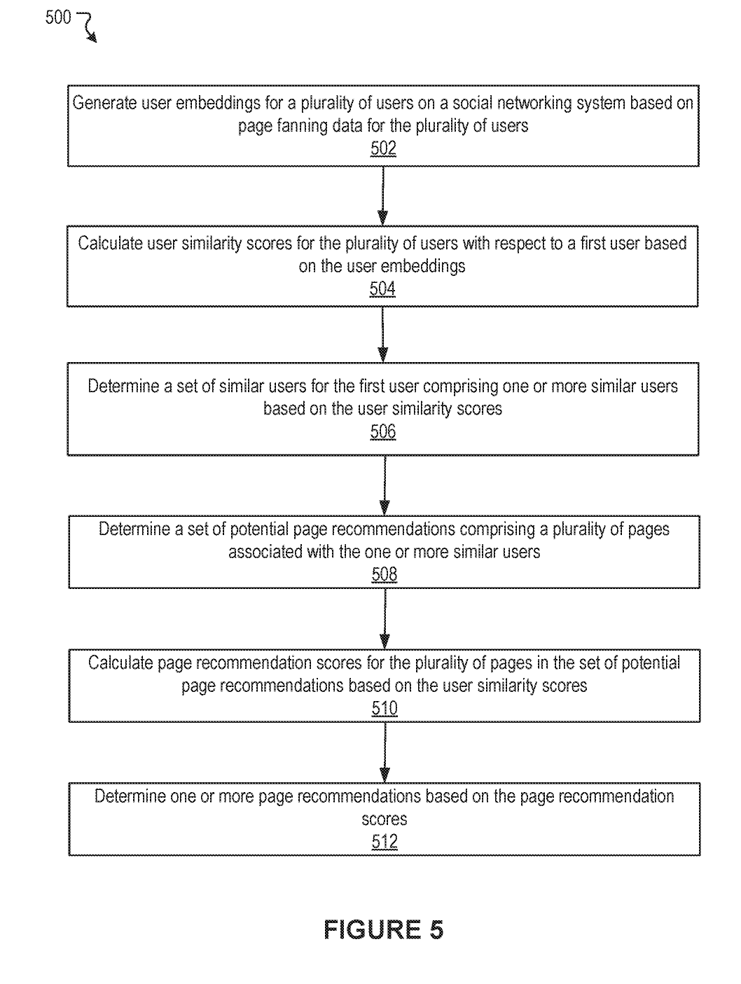

FIG. 5 illustrates an example method 500 associated with providing page recommendations based on user clustering, according to an embodiment of the present disclosure. It should be appreciated that there can be additional, fewer, or alternative steps performed in similar or alternative orders, or in parallel, within the scope of the various embodiments discussed herein unless otherwise stated.

At block 502, the example method 500 can generate user embeddings for a plurality of users on a social networking system based on page fanning data for the plurality of users. At block 504, the example method 500 can calculate user similarity scores for the plurality of users with respect to a first user based on the user embeddings. At block 506, the example method 500 can determine a set of similar users for the first user comprising one or more similar users based on the user similarity scores. At block 508, the example method 500 can determine a set of potential page recommendations comprising a plurality of pages associated with the one or more similar users. At block 510, the example method 500 can calculate page recommendation scores for the plurality of pages in the set of potential page recommendations based on the user similarity scores. At block 512, the example method 500 can determine one or more page recommendations based on the page recommendation scores.

It is contemplated that there can be many other uses, applications, and/or variations associated with the various embodiments of the present disclosure. For example, in some cases, users can choose whether or not to opt-in to utilize the disclosed technology. The disclosed technology can also ensure that various privacy settings and preferences are maintained and can prevent private information from being divulged. In another example, various embodiments of the present disclosure can learn, improve, and/or be refined over time.

### Social Networking System—Example Implementation

FIG. 6 illustrates a network diagram of an example system 600 that can be utilized in various scenarios, according to an embodiment of the present disclosure. The system 600 includes one or more user devices 610, one or more external systems 620, a social networking system (or service) 630, and a network 650. In an embodiment, the social networking service, provider, and/or system discussed in connection with the embodiments described above may be implemented as the social networking system 630. For purposes of illustration, the embodiment of the system 600, shown by FIG. 6, includes a single external system 620 and a single user device 610. However, in other embodiments, the system 600 may include more user devices 610 and/or more external systems 620. In certain embodiments, the social networking system 630 is operated by a social network provider, whereas the external systems 620 are separate from the social networking system 630 in that they may be operated by different entities. In various embodiments, however, the social networking system 630 and the external systems 620 operate in conjunction to provide social networking services to users (or members) of the social networking system 630. In this sense, the social networking system 630 provides a platform or backbone, which other systems, such as external systems 620, may use to provide social networking services and functionalities to users across the Internet.

The user device 610 comprises one or more computing devices that can receive input from a user and transmit and receive data via the network 650. In one embodiment, the user device 610 is a conventional computer system executing, for example, a Microsoft Windows compatible operating system (OS), Apple OS X, and/or a Linux distribution. In another embodiment, the user device 610 can be a device having computer functionality, such as a smart-phone, a tablet, a personal digital assistant (PDA), a mobile telephone, etc. The user device 610 is configured to communicate via the network 650. The user device 610 can execute an application, for example, a browser application that allows a user of the user device 610 to interact with the social networking system 630. In another embodiment, the user device 610 interacts with the social networking system 630 through an application programming interface (API) provided by the native operating system of the user device 610, such as iOS and ANDROID. The user device 610 is configured to communicate with the external system 620 and the social networking system 630 via the network 650, which may comprise any combination of local area and/or wide area networks, using wired and/or wireless communication systems.

In one embodiment, the network 650 uses standard communications technologies and protocols. Thus, the network 650 can include links using technologies such as Ethernet, 802.11, worldwide interoperability for microwave access (WiMAX), 3G, 4G, CDMA, GSM, LTE, digital subscriber line (DSL), etc. Similarly, the networking protocols used on the network 650 can include multiprotocol label switching (MPLS), transmission control protocol/Internet protocol (TCP/IP), User Datagram Protocol (UDP), hypertext transport protocol (HTTP), simple mail transfer protocol (SMTP), file transfer protocol (FTP), and the like. The data exchanged over the network 650 can be represented using technologies and/or formats including hypertext markup language (HTML) and extensible markup language (XML). In addition, all or some links can be encrypted using conventional encryption technologies such as secure sockets layer (SSL), transport layer security (TLS), and Internet Protocol security (IPsec).

In one embodiment, the user device 610 may display content from the external system 620 and/or from the social networking system 630 by processing a markup language document 614 received from the external system 620 and from the social networking system 630 using a browser application 612. The markup language document 614 identifies content and one or more instructions describing formatting or presentation of the content. By executing the instructions included in the markup language document 614, the browser application 612 displays the identified content using the format or presentation described by the markup language document 614. For example, the markup language document 614 includes instructions for generating and displaying a web page having multiple frames that include text and/or image data retrieved from the external system 620 and the social networking system 630. In various embodiments, the markup language document 614 comprises a data file including extensible markup language (XML) data, extensible hypertext markup language (XHTML) data, or other markup language data. Additionally, the markup language document 614 may include JavaScript Object Notation (JSON) data, JSON with padding (JSONP), and JavaScript data to facilitate data-interchange between the external system 620 and the user device 610. The browser application 612 on the user device 610 may use a JavaScript compiler to decode the markup language document 614.

The markup language document 614 may also include, or link to, applications or application frameworks such as FLASH™ or Unity™ applications, the SilverLight™ application framework, etc.

In one embodiment, the user device 610 also includes one or more cookies 616 including data indicating whether a user of the user device 610 is logged into the social networking system 630, which may enable modification of the data communicated from the social networking system 630 to the user device 610.

The external system 620 includes one or more web servers that include one or more web pages 622a, 622b, which are communicated to the user device 610 using the network 650. The external system 620 is separate from the social networking system 630. For example, the external system 620 is associated with a first domain, while the social networking system 630 is associated with a separate social networking domain. Web pages 622a, 622b, included in the external system 620, comprise markup language documents 614 identifying content and including instructions specifying formatting or presentation of the identified content.

The social networking system 630 includes one or more computing devices for a social network, including a plurality of users, and providing users of the social network with the ability to communicate and interact with other users of the social network. In some instances, the social network can be represented by a graph, i.e., a data structure including edges and nodes. Other data structures can also be used to represent the social network, including but not limited to databases, objects, classes, meta elements, files, or any other data structure. The social networking system 630 may be administered, managed, or controlled by an operator. The operator of the social networking system 630 may be a human being, an automated application, or a series of applications for managing content, regulating policies, and collecting usage metrics within the social networking system 630. Any type of operator may be used.

Users may join the social networking system 630 and then add connections to any number of other users of the social networking system 630 to whom they desire to be connected. As used herein, the term “friend” refers to any other user of the social networking system 630 to whom a user has formed a connection, association, or relationship via the social networking system 630. For example, in an embodiment, if users in the social networking system 630 are represented as nodes in the social graph, the term “friend” can refer to an edge formed between and directly connecting two user nodes.

Connections may be added explicitly by a user or may be automatically created by the social networking system 630 based on common characteristics of the users (e.g., users who are alumni of the same educational institution). For example, a first user specifically selects a particular other user to be a friend. Connections in the social networking system 630 are usually in both directions, but need not be, so the terms “user” and “friend” depend on the frame of reference. Connections between users of the social networking system 630 are usually bilateral (“two-way”), or “mutual,” but connections may also be unilateral, or “one-way.” For example, if Bob and Joe are both users of the social networking system 630 and connected to each other, Bob and Joe are each other's connections. If, on the other hand, Bob wishes to connect to Joe to view data communicated to the social networking system 630 by Joe, but Joe does not wish to form a mutual connection, a unilateral connection may be established. The connection between users may be a direct connection; however, some embodiments of the social networking system 630 allow the connection to be indirect via one or more levels of connections or degrees of separation.

In addition to establishing and maintaining connections between users and allowing interactions between users, the social networking system 630 provides users with the ability to take actions on various types of items supported by the social networking system 630. These items may include groups or networks (i.e., social networks of people, entities, and concepts) to which users of the social networking system 630 may belong, events or calendar entries in which a user might be interested, computer-based applications that a user may use via the social networking system 630, transactions that allow users to buy or sell items via services provided by or through the social networking system 630, and interactions with advertisements that a user may perform on or off the social networking system 630. These are just a few examples of the items upon which a user may act on the social networking system 630, and many others are possible. A user may interact with anything that is capable of being represented in the social networking system 630 or in the external system 620, separate from the social networking system 630, or coupled to the social networking system 630 via the network 650.

The social networking system 630 is also capable of linking a variety of entities. For example, the social networking system 630 enables users to interact with each other as well as external systems 620 or other entities through an API, a web service, or other communication channels. The social networking system 630 generates and maintains the “social graph” comprising a plurality of nodes interconnected by a plurality of edges. Each node in the social graph may represent an entity that can act on another node and/or that can be acted on by another node. The social graph may include various types of nodes. Examples of types of nodes include users, non-person entities, content items, web pages, groups, activities, messages, concepts, and any other things that can be represented by an object in the social networking system 630. An edge between two nodes in the social graph may represent a particular kind of connection, or association, between the two nodes, which may result from node relationships or from an action that was performed by one of the nodes on the other node. In some cases, the edges between nodes can be weighted. The weight of an edge can represent an attribute associated with the edge, such as a strength of the connection or association between nodes. Different types of edges can be provided with different weights. For example, an edge created when one user “likes” another user may be given one weight, while an edge created when a user befriends another user may be given a different weight.

As an example, when a first user identifies a second user as a friend, an edge in the social graph is generated connecting a node representing the first user and a second node representing the second user. As various nodes relate or interact with each other, the social networking system 630 modifies edges connecting the various nodes to reflect the relationships and interactions.

The social networking system 630 also includes user-generated content, which enhances a user's interactions with the social networking system 630. User-generated content may include anything a user can add, upload, send, or “post” to the social networking system 630. For example, a user communicates posts to the social networking system 630 from a user device 610. Posts may include data such as status updates or other textual data, location information, images such as photos, videos, links, music or other similar data and/or media. Content may also be added to the social networking system 630 by a third party. Content “items” are represented as objects in the social networking system 630. In this way, users of the social networking system 630 are encouraged to communicate with each other by posting text and content items of various types of media through various communication channels. Such communication increases the interaction of users with each other and increases the frequency with which users interact with the social networking system 630.

The social networking system 630 includes a web server 632, an API request server 634, a user profile store 636, a connection store 638, an action logger 640, an activity log 642, and an authorization server 644. In an embodiment of the invention, the social networking system 630 may include additional, fewer, or different components for various applications. Other components, such as network interfaces, security mechanisms, load balancers, failover servers, management and network operations consoles, and the like are not shown so as to not obscure the details of the system.

The user profile store 636 maintains information about user accounts, including biographic, demographic, and other types of descriptive information, such as work experience, educational history, hobbies or preferences, location, and the like that has been declared by users or inferred by the social networking system 630. This information is stored in the user profile store 636 such that each user is uniquely identified. The social networking system 630 also stores data describing one or more connections between different users in the connection store 638. The connection information may indicate users who have similar or common work experience, group memberships, hobbies, or educational history. Additionally, the social networking system 630 includes user-defined connections between different users, allowing users to specify their relationships with other users. For example, user-defined connections allow users to generate relationships with other users that parallel the users' real-life relationships, such as friends, co-workers, partners, and so forth. Users may select from predefined types of connections, or define their own connection types as needed. Connections with other nodes in the social networking system 630, such as non-person entities, buckets, cluster centers, images, interests, pages, external systems, concepts, and the like are also stored in the connection store 638.

The social networking system 630 maintains data about objects with which a user may interact. To maintain this data, the user profile store 636 and the connection store 638 store instances of the corresponding type of objects maintained by the social networking system 630. Each object type has information fields that are suitable for storing information appropriate to the type of object. For example, the user profile store 636 contains data structures with fields suitable for describing a user's account and information related to a user's account. When a new object of a particular type is created, the social networking system 630 initializes a new data structure of the corresponding type, assigns a unique object identifier to it, and begins to add data to the object as needed. This might occur, for example, when a user becomes a user of the social networking system 630, the social networking system 630 generates a new instance of a user profile in the user profile store 636, assigns a unique identifier to the user account, and begins to populate the fields of the user account with information provided by the user.

The connection store 638 includes data structures suitable for describing a user's connections to other users, connections to external systems 620 or connections to other entities. The connection store 638 may also associate a connection type with a user's connections, which may be used in conjunction with the user's privacy setting to regulate access to information about the user. In an embodiment of the invention, the user profile store 636 and the connection store 638 may be implemented as a federated database.

Data stored in the connection store 638, the user profile store 636, and the activity log 642 enables the social networking system 630 to generate the social graph that uses nodes to identify various objects and edges connecting nodes to identify relationships between different objects. For example, if a first user establishes a connection with a second user in the social networking system 630, user accounts of the first user and the second user from the user profile store 636 may act as nodes in the social graph. The connection between the first user and the second user stored by the connection store 638 is an edge between the nodes associated with the first user and the second user. Continuing this example, the second user may then send the first user a message within the social networking system 630. The action of sending the message, which may be stored, is another edge between the two nodes in the social graph representing the first user and the second user. Additionally, the message itself may be identified and included in the social graph as another node connected to the nodes representing the first user and the second user.

In another example, a first user may tag a second user in an image that is maintained by the social networking system 630 (or, alternatively, in an image maintained by another system outside of the social networking system 630). The image may itself be represented as a node in the social networking system 630. This tagging action may create edges between the first user and the second user as well as create an edge between each of the users and the image, which is also a node in the social graph. In yet another example, if a user confirms attending an event, the user and the event are nodes obtained from the user profile store 636, where the attendance of the event is an edge between the nodes that may be retrieved from the activity log 642. By generating and maintaining the social graph, the social networking system 630 includes data describing many different types of objects and the interactions and connections among those objects, providing a rich source of socially relevant information.

The web server 632 links the social networking system 630 to one or more user devices 610 and/or one or more external systems 620 via the network 650. The web server 632 serves web pages, as well as other web-related content, such as Java, JavaScript, Flash, XML, and so forth. The web server 632 may include a mail server or other messaging functionality for receiving and routing messages between the social networking system 630 and one or more user devices 610. The messages can be instant messages, queued messages (e.g., email), text and SMS messages, or any other suitable messaging format.

The API request server 634 allows one or more external systems 620 and user devices 610 to call access information from the social networking system 630 by calling one or more API functions. The API request server 634 may also allow external systems 620 to send information to the social networking system 630 by calling APIs. The external system 620, in one embodiment, sends an API request to the social networking system 630 via the network 650, and the API request server 634 receives the API request. The API request server 634 processes the request by calling an API associated with the API request to generate an appropriate response, which the API request server 634 communicates to the external system 620 via the network 650. For example, responsive to an API request, the API request server 634 collects data associated with a user, such as the user's connections that have logged into the external system 620, and communicates the collected data to the external system 620. In another embodiment, the user device 610 communicates with the social networking system 630 via APIs in the same manner as external systems 620.

The action logger 640 is capable of receiving communications from the web server 632 about user actions on and/or off the social networking system 630. The action logger 640 populates the activity log 642 with information about user actions, enabling the social networking system 630 to discover various actions taken by its users within the social networking system 630 and outside of the social networking system 630. Any action that a particular user takes with respect to another node on the social networking system 630 may be associated with each user's account, through information maintained in the activity log 642 or in a similar database or other data repository. Examples of actions taken by a user within the social networking system 630 that are identified and stored may include, for example, adding a connection to another user, sending a message to another user, reading a message from another user, viewing content associated with another user, attending an event posted by another user, posting an image, attempting to post an image, or other actions interacting with another user or another object. When a user takes an action within the social networking system 630, the action is recorded in the activity log 642. In one embodiment, the social networking system 630 maintains the activity log 642 as a database of entries. When an action is taken within the social networking system 630, an entry for the action is added to the activity log 642. The activity log 642 may be referred to as an action log.

Additionally, user actions may be associated with concepts and actions that occur within an entity outside of the social networking system 630, such as an external system 620 that is separate from the social networking system 630. For example, the action logger 640 may receive data describing a user's interaction with an external system 620 from the web server 632. In this example, the external system 620 reports a user's interaction according to structured actions and objects in the social graph.

Other examples of actions where a user interacts with an external system 620 include a user expressing an interest in an external system 620 or another entity, a user posting a comment to the social networking system 630 that discusses an external system 620 or a web page 622a within the external system 620, a user posting to the social networking system 630 a Uniform Resource Locator (URL) or other identifier associated with an external system 620, a user attending an event associated with an external system 620, or any other action by a user that is related to an external system 620. Thus, the activity log 642 may include actions describing interactions between a user of the social networking system 630 and an external system 620 that is separate from the social networking system 630.

The authorization server 644 enforces one or more privacy settings of the users of the social networking system 630. A privacy setting of a user determines how particular information associated with a user can be shared. The privacy setting comprises the specification of particular information associated with a user and the specification of the entity or entities with whom the information can be shared. Examples of entities with which information can be shared may include other users, applications, external systems 620, or any entity that can potentially access the information. The information that can be shared by a user comprises user account information, such as profile photos, phone numbers associated with the user, user's connections, actions taken by the user such as adding a connection, changing user profile information, and the like.

The privacy setting specification may be provided at different levels of granularity. For example, the privacy setting may identify specific information to be shared with other users; the privacy setting identifies a work phone number or a specific set of related information, such as, personal information including profile photo, home phone number, and status. Alternatively, the privacy setting may apply to all the information associated with the user. The specification of the set of entities that can access particular information can also be specified at various levels of granularity. Various sets of entities with which information can be shared may include, for example, all friends of the user, all friends of friends, all applications, or all external systems 620. One embodiment allows the specification of the set of entities to comprise an enumeration of entities. For example, the user may provide a list of external systems 620 that are allowed to access certain information. Another embodiment allows the specification to comprise a set of entities along with exceptions that are not allowed to access the information. For example, a user may allow all external systems 620 to access the user's work information, but specify a list of external systems 620 that are not allowed to access the work information. Certain embodiments call the list of exceptions that are not allowed to access certain information a “block list”. External systems 620 belonging to a block list specified by a user are blocked from accessing the information specified in the privacy setting. Various combinations of granularity of specification of information, and granularity of specification of entities, with which information is shared are possible. For example, all personal information may be shared with friends whereas all work information may be shared with friends of friends.

The authorization server 644 contains logic to determine if certain information associated with a user can be accessed by a user's friends, external systems 620, and/or other applications and entities. The external system 620 may need authorization from the authorization server 644 to access the user's more private and sensitive information, such as the user's work phone number. Based on the user's privacy settings, the authorization server 644 determines if another user, the external system 620, an application, or another entity is allowed to access information associated with the user, including information about actions taken by the user.

In some embodiments, the social networking system 630 can include a user clustering module 646. The user clustering module 646 can, for example, be implemented as the user clustering module 102, as discussed in more detail herein. As discussed previously, it should be appreciated that there can be many variations or other possibilities. For example, in some embodiments, one or more functionalities of the user clustering module 646 can be implemented in the user device 610.

### Hardware Implementation

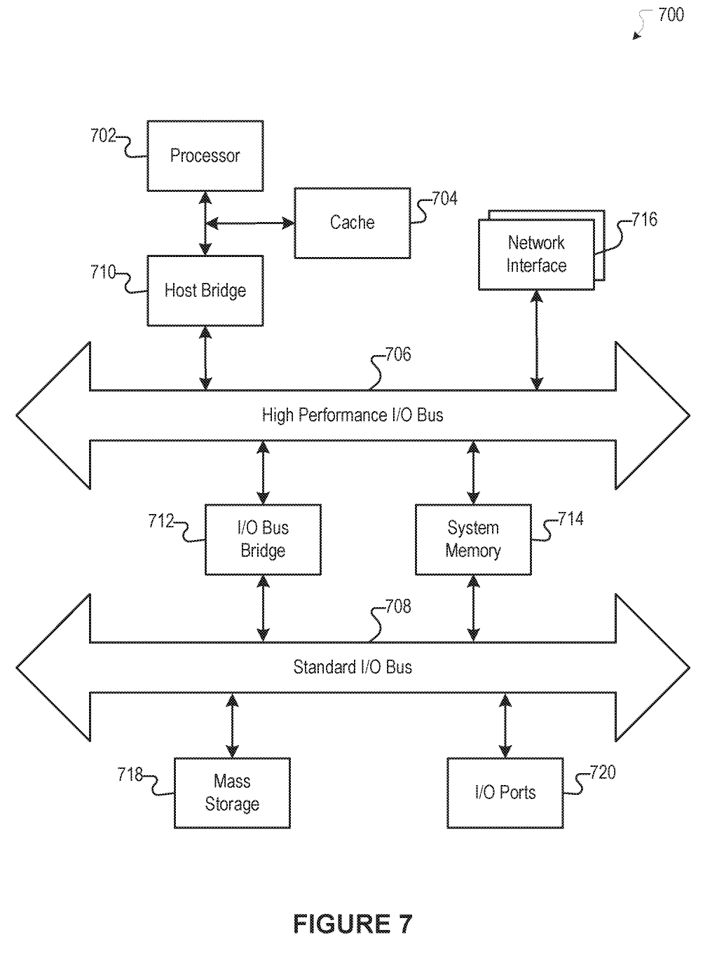

The foregoing processes and features can be implemented by a wide variety of machine and computer system architectures and in a wide variety of network and computing environments. FIG. 7 illustrates an example of a computer system 700 that may be used to implement one or more of the embodiments described herein according to an embodiment of the invention. The computer system 700 includes sets of instructions for causing the computer system 700 to perform the processes and features discussed herein. The computer system 700 may be connected (e.g., networked) to other machines. In a networked deployment, the computer system 700 may operate in the capacity of a server machine or a client machine in a client-server network environment, or as a peer machine in a peer-to-peer (or distributed) network environment. In an embodiment of the invention, the computer system 700 may be the social networking system 630, the user device 610, and the external system 620, or a component thereof. In an embodiment of the invention, the computer system 700 may be one server among many that constitutes all or part of the social networking system 630.

The computer system 700 includes a processor 702, a cache 704, and one or more executable modules and drivers, stored on a computer-readable medium, directed to the processes and features described herein. Additionally, the computer system 700 includes a high performance input/output (I/O) bus 706 and a standard I/O bus 708. A host bridge 710 couples processor 702 to high performance I/O bus 706, whereas I/O bus bridge 712 couples the two buses 706 and 708 to each other. A system memory 714 and one or more network interfaces 716 couple to high performance I/O bus 706. The computer system 700 may further include video memory and a display device coupled to the video memory (not shown). Mass storage 718 and I/O ports 720 couple to the standard I/O bus 708. The computer system 700 may optionally include a keyboard and pointing device, a display device, or other input/output devices (not shown) coupled to the standard I/O bus 708. Collectively, these elements are intended to represent a broad category of computer hardware systems, including but not limited to computer systems based on the x86-compatible processors manufactured by Intel Corporation of Santa Clara, Calif., and the x86-compatible processors manufactured by Advanced Micro Devices (AMD), Inc., of Sunnyvale, Calif., as well as any other suitable processor.

An operating system manages and controls the operation of the computer system 700, including the input and output of data to and from software applications (not shown). The operating system provides an interface between the software applications being executed on the system and the hardware components of the system. Any suitable operating system may be used, such as the LINUX Operating System, the Apple Macintosh Operating System, available from Apple Computer Inc. of Cupertino, Calif., UNIX operating systems, Microsoft® Windows® operating systems, BSD operating systems, and the like. Other implementations are possible.

The elements of the computer system 700 are described in greater detail below. In particular, the network interface 716 provides communication between the computer system 700 and any of a wide range of networks, such as an Ethernet (e.g., IEEE 802.3) network, a backplane, etc. The mass storage 718 provides permanent storage for the data and programming instructions to perform the above-described processes and features implemented by the respective computing systems identified above, whereas the system memory 714 (e.g., DRAM) provides temporary storage for the data and programming instructions when executed by the processor 702. The I/O ports 720 may be one or more serial and/or parallel communication ports that provide communication between additional peripheral devices, which may be coupled to the computer system 700.

The computer system 700 may include a variety of system architectures, and various components of the computer system 700 may be rearranged. For example, the cache 704 may be on-chip with processor 702. Alternatively, the cache 704 and the processor 702 may be packed together as a “processor module”, with processor 702 being referred to as the “processor core”. Furthermore, certain embodiments of the invention may neither require nor include all of the above components. For example, peripheral devices coupled to the standard I/O bus 708 may couple to the high performance I/O bus 706. In addition, in some embodiments, only a single bus may exist, with the components of the computer system 700 being coupled to the single bus. Moreover, the computer system 700 may include additional components, such as additional processors, storage devices, or memories.

In general, the processes and features described herein may be implemented as part of an operating system or a specific application, component, program, object, module, or series of instructions referred to as “programs”. For example, one or more programs may be used to execute specific processes described herein. The programs typically comprise one or more instructions in various memory and storage devices in the computer system 700 that, when read and executed by one or more processors, cause the computer system 700 to perform operations to execute the processes and features described herein. The processes and features described herein may be implemented in software, firmware, hardware (e.g., an application specific integrated circuit), or any combination thereof.

In one implementation, the processes and features described herein are implemented as a series of executable modules run by the computer system 700, individually or collectively in a distributed computing environment. The foregoing modules may be realized by hardware, executable modules stored on a computer-readable medium (or machine-readable medium), or a combination of both. For example, the modules may comprise a plurality or series of instructions to be executed by a processor in a hardware system, such as the processor 702. Initially, the series of instructions may be stored on a storage device, such as the mass storage 718. However, the series of instructions can be stored on any suitable computer readable storage medium. Furthermore, the series of instructions need not be stored locally, and could be received from a remote storage device, such as a server on a network, via the network interface 716. The instructions are copied from the storage device, such as the mass storage 718, into the system memory 714 and then accessed and executed by the processor 702. In various implementations, a module or modules can be executed by a processor or multiple processors in one or multiple locations, such as multiple servers in a parallel processing environment.

Examples of computer-readable media include, but are not limited to, recordable type media such as volatile and non-volatile memory devices; solid state memories; floppy and other removable disks; hard disk drives; magnetic media; optical disks (e.g., Compact Disk Read-Only Memory (CD ROMS), Digital Versatile Disks (DVDs)); other similar non-transitory (or transitory), tangible (or non-tangible) storage medium; or any type of medium suitable for storing, encoding, or carrying a series of instructions for execution by the computer system 700 to perform any one or more of the processes and features described herein.

For purposes of explanation, numerous specific details are set forth in order to provide a thorough understanding of the description. It will be apparent, however, to one skilled in the art that embodiments of the disclosure can be practiced without these specific details. In some instances, modules, structures, processes, features, and devices are shown in block diagram form in order to avoid obscuring the description. In other instances, functional block diagrams and flow diagrams are shown to represent data and logic flows. The components of block diagrams and flow diagrams (e.g., modules, blocks, structures, devices, features, etc.) may be variously combined, separated, removed, reordered, and replaced in a manner other than as expressly described and depicted herein.

Reference in this specification to “one embodiment”, “an embodiment”, “other embodiments”, “one series of embodiments”, “some embodiments”, “various embodiments”, or the like means that a particular feature, design, structure, or characteristic described in connection with the embodiment is included in at least one embodiment of the disclosure. The appearances of, for example, the phrase “in one embodiment” or “in an embodiment” in various places in the specification are not necessarily all referring to the same embodiment, nor are separate or alternative embodiments mutually exclusive of other embodiments. Moreover, whether or not there is express reference to an “embodiment” or the like, various features are described, which may be variously combined and included in some embodiments, but also variously omitted in other embodiments. Similarly, various features are described that may be preferences or requirements for some embodiments, but not other embodiments.

The language used herein has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A computer-implemented method comprising:
calculating, by a computing system, user similarity scores for a plurality of users on a social networking system with respect to a first user based on user embeddings for the plurality of users and the first user;
determining, by the computing system, a set of similar users comprising a plurality of similar users for the first user based on the user similarity scores;
calculating, by the computing system, page recommendation scores for a plurality of pages associated with the plurality of similar users based on the user similarity scores; and
determining, by the computing system, one or more page recommendations for the first user based on the page recommendation scores.

2. The computer-implemented method of claim 1, wherein, for each user in the plurality of users, the user similarity score is calculated based on a cosine similarity between the embedding for the user and the embedding for the first user.

3. The computer-implemented method of claim 1, wherein, for each page of the plurality of pages, the page recommendation score is calculated based on the user similarity scores for all similar users that have fanned the page.

4. The computer-implemented method of claim 3, wherein, for each page of the plurality of pages, the page recommendation score is calculated based on a sum of the user similarity scores for all similar users that have fanned the page.

5. The computer-implemented method of claim 1, further comprising:
determining a set of potential page recommendations, wherein the set of potential page recommendations comprises all pages fanned by the similar users in the set of similar users that have not already been fanned by the first user, wherein
the calculating page recommendation scores for the plurality of pages associated with the plurality of similar users comprises calculating page recommendation scores for each page in the set of potential page recommendations.

6. The computer-implemented method of claim 1, wherein the user embeddings for the plurality of users and the first user are generating using paragraph embeddings.

7. The computer-implemented method of claim 6, wherein,
training data for the user embeddings comprises a plurality of sentences comprising one or more words,
each sentence of the plurality of sentences is associated with a user of the plurality of users, and
for each sentence, each word in the sentence is associated with a page that the user associated with the sentence has fanned.

8. The computer-implemented method of claim 1, wherein the user embeddings for the plurality of users and the first user are generated using a linear embedding system augmented with traits.

9. The computer-implemented method of claim 1, wherein the user embeddings for the plurality of users and the first user are generated using neural linguistic embeddings.

10. The computer-implemented method of claim 9, wherein,
training data for the user embeddings comprises a plurality of sentences comprising one or more words,
each sentence of the plurality of sentences is associated with a page on the social networking system, and
for each sentence, each word in the sentence is associated with user that has fanned the page associated with the sentence.

11. A system comprising:
at least one processor; and
a memory storing instructions that, when executed by the at least one processor, cause the system to perform a method comprising:
calculating user similarity scores for a plurality of users on a social networking system with respect to a first user based on user embeddings for the plurality of users and the first user;
determining a set of similar users comprising a plurality of similar users for the first user based on the user similarity scores;
calculating page recommendation scores for a plurality of pages associated with the plurality of similar users based on the user similarity scores; and
determining one or more page recommendations for the first user based on the page recommendation scores.

12. The system of claim 11, wherein, for each user in the plurality of users, the user similarity score is calculated based on a cosine similarity between the embedding for the user and the embedding for the first user.

13. The system of claim 11, wherein, for each page of the plurality of pages, the page recommendation score is calculated based on the user similarity scores for all similar users that have fanned the page.

14. The system of claim 13, wherein, for each page of the plurality of pages, the page recommendation score is calculated based on a sum of the user similarity scores for all similar users that have fanned the page.

15. The system of claim 11, wherein the method further comprises:
determining a set of potential page recommendations, wherein the set of potential page recommendations comprises all pages fanned by the similar users in the set of similar users that have not already been fanned by the first user, wherein
the calculating page recommendation scores for the plurality of pages associated with the plurality of similar users comprises calculating page recommendation scores for each page in the set of potential page recommendations.

16. A non-transitory computer-readable storage medium including instructions that, when executed by at least one processor of a computing system, cause the computing system to perform a method comprising:
calculating user similarity scores for a plurality of users on a social networking system with respect to a first user based on user embeddings for the plurality of users and the first user;
determining a set of similar users comprising a plurality of similar users for the first user based on the user similarity scores;
calculating page recommendation scores for a plurality of pages associated with the plurality of similar users based on the user similarity scores; and
determining one or more page recommendations for the first user based on the page recommendation scores.

17. The non-transitory computer-readable storage medium of claim 16, wherein, for each user in the plurality of users, the user similarity score is calculated based on a cosine similarity between the embedding for the user and the embedding for the first user.

18. The non-transitory computer-readable storage medium of claim 16, wherein, for each page of the plurality of pages, the page recommendation score is calculated based on the user similarity scores for all similar users that have fanned the page.

19. The non-transitory computer-readable storage medium of claim 18, wherein, for each page of the plurality of pages, the page recommendation score is calculated based on a sum of the user similarity scores for all similar users that have fanned the page.

20. The non-transitory computer-readable storage medium of claim 16, wherein the method further comprises:
determining a set of potential page recommendations, wherein the set of potential page recommendations comprises all pages fanned by the similar users in the set of similar users that have not already been fanned by the first user, wherein
the calculating page recommendation scores for the plurality of pages associated with the plurality of similar users comprises calculating page recommendation scores for each page in the set of potential page recommendations.
